(19) United States
(12) Patent Application Publication
(10) Pub. No.: US 2002/0137417 A1
(43) Pub. Date: Sep. 26, 2002

(54) Textile material for garments

(76) Inventor: Gerold Tebbe, Monte Carlo (MC)

Correspondence Address: FACTOR & PARTNERS, LLC, 1327 W. WASHINGTON BLVD., SUITE 5G/H, CHICAGO, IL, 60607, US

(21) Appl. No.: 10/095,299

(22) Filed: Mar. 11, 2002

(30) Foreign Application Priority Data
Mar. 14, 2001 (DE) 10112 122.9

(51) Int. Cl. B32B 27/04; B32B 27/12; B32B 27/02

(52) U.S. Cl. 442/130; 428/402.2; 428/323; 428/325; 428/327

(57) ABSTRACT

The invention relates to a textile material for a garment (10) which has microparticles bound in a binding agent in a demarcated area which will later face outwardly on the garment and can have, for example, the form of a registered trademark (12). The microparticles impart a changed appearance to the textile material in the demarcated area. The microparticles preferably contain fluorescent, phosphorescent, thermochromic or photochromic colorants. The purpose of the microparticles is to make imitation of the textile material more difficult.

The invention relates to a textile material for garments.

Product piracy in the field of textiles does not stop short of protected fabric designs. In order to protect the original product a marking which should be difficult to imitate, similar to the watermark in paper, would be desirable.

It is the object of the present invention to provide such a marking.

This object is met by a textile material for a garment which is characterized in that it has microparticles bound by a binding agent in a demarcated area and in that the microparticles impart a changed appearance to the material in the demarcated area.

According to the invention a pattern which can take the form, for example, of a registered trademark is applied to the textile material by means of microparticles in a binding agent. The microparticles are usually present on the side of the material later facing outwardly on the garment, but can also be present on the inside.

These microparticles are so constituted that they impart a different appearance to the textile material in the demarcated area. This is the case, for example, if the particles are present in a colorless but opaque or transparent form on a colored material, or if they have a different color to that of the material, e.g. a metallic color.

Advantageous further developments of the invention are specified in the subsidiary claims.

A further development of the invention is characterized in that the microparticles include ceramic material or glass.

A further development of the invention is characterized in that the microparticles include a transparent plastics material.

A further development of the invention is characterized in that the microparticles include microcapsules.

A further development of the invention is characterized in that the microparticles contain a chemical compound which is selected from a fluorescent compound, a phosphorescent compound, a thermochromic compound, a photochromic compound and mixtures thereof.

A further development of the invention is characterized in that the thermochromic compound changes its color at a temperature between 20° C. and 40° C.

A further development of the invention is characterized in that the photochromic compound has a different color or a different color saturation in daylight and in artificial light.

A further development of the invention is characterized in that the microparticles include ceramic material or glass and in that the chemical compound is an inorganic compound.

A further development of the invention is characterized in that the microparticles include a transparent plastics material and in that the chemical compound is an organic compound.

A further development of the invention is characterized in that the microparticles release the chemical compound when the textile material is ironed.

A further development of the invention is characterized in that the microparticles are applied by screen printing.

A further development of the invention is characterized in that the microparticles have a magnitude in the range from 0.5 to 500 μm.

A further development of the invention is characterized in that the binding agent or the microparticles can be washed out.

A further development of the invention is characterized in that the microparticles include thermoplastic material.

A further development of the invention is characterized in that the microparticles include a metallic pigment.

A further development of the invention is characterized in that the microparticles are at least partially covered by an exposed photographic coating.

A further development of the invention is characterized in that the photographic coating has been exposed using a hologram.

A further development of the invention is characterized in that the microcapsules together with solid protective bodies having a larger diameter than the microcapsules are printed on using the screen printing process.

The microcapsules can impart a different appearance to the material simply by their opacity, their reflection or, if applicable, by their coloring of the area of material on which they are present.

A textile material with a thermochromic compound changes its color and/or its color saturation when it is worn by a user. An interesting optical effect is produced in particular when the color-change temperature is such that the color can change even during wearing of the garment, depending on the ambient temperature in the environment of the garment. The color-change temperature can also be precisely set so that the demarcated area is conspicuous when the garment is not being worn but recedes optically when the garment is worn.

In the case of a textile material with a colorant which responds differently to daylight and to artificial light, the appearance of the demarcated area having microparticles changes with the lighting conditions. Furthermore, the change of color and/or color saturation of the demarcated area can be so specified that this area is visually striking in standard lighting conditions, or that it is striking only in non-standard lighting conditions.

Glass, ceramic or plastics particles used according to the invention advantageously contain inorganic fluorescent, phosphorescent, photochromic or thermochromic dyes/pigments. For example, macroscopic jewelry items (rings) of ceramic materials containing thermochromic compounds which change color under the influence of body heat are known. Photochromic (or phototropic) glasses are known, e.g. as spectacles lenses. The two last-mentioned materials are especially suitable as microparticles for the present invention, since imitation of them is costly and therefore is hardly to be considered for cheap pirated products.

If the microparticles include a transparent plastics material, e.g. acrylic glass, in the case of fluorescent, phosphorescent, photochromic or thermochromic dyes/pigments, organic dyes/pigments are advantageously used.

If the microparticles are microcapsules and contain one or more fluorescent, phosphorescent, photochromic or thermochromic dyes, they are preferably so constituted that they rupture on first ironing of the textile material and release the dye/pigment, the dye/pigment being absorbed by the layer of binding agent surrounding the microcapsules and in some cases being passed on to the textile. In this case the dye/pigment can be inorganic or organic, and fluorescent or phosphorescent dyes/pigments are preferred.

If the binding agent and/or the microparticles can be washed out, the demarcated area can be washed out by washing the garment. This is of interest in cases in which a warranty function of the demarcated area is required only until the garment has reached the end user. After the first wash the garment is unmarked.

In the case of a textile material with thermoplastic microparticles the end user can decide whether or not he wishes to bind the microparticles permanently to the textile material by ironing.

In the case of a textile material with microparticles covered by a photographic coating the demarcated area can be provided with a photographic image.

In this case holographic exposure yields especially attractive optical effects, as the marked area shows a hologram. Particularly when using microparticles made of glass aesthetically appealing and characteristic hologram reflections are produced.

Application of microcapsules together with larger protective particles by screen printing ensures that the microcapsules are not destroyed by the squeegee of the screen printing device when the printing ink is pressed through the screen. This is especially advantageous in the case of continuous screen printing and rotary screen printing, as the squeegee passes over the screen under high pressure in these processes.

The invention will now be described with reference to examples and to the appended drawings, in which:

FIG. 1 shows a shirt made of a textile material according to the invention;

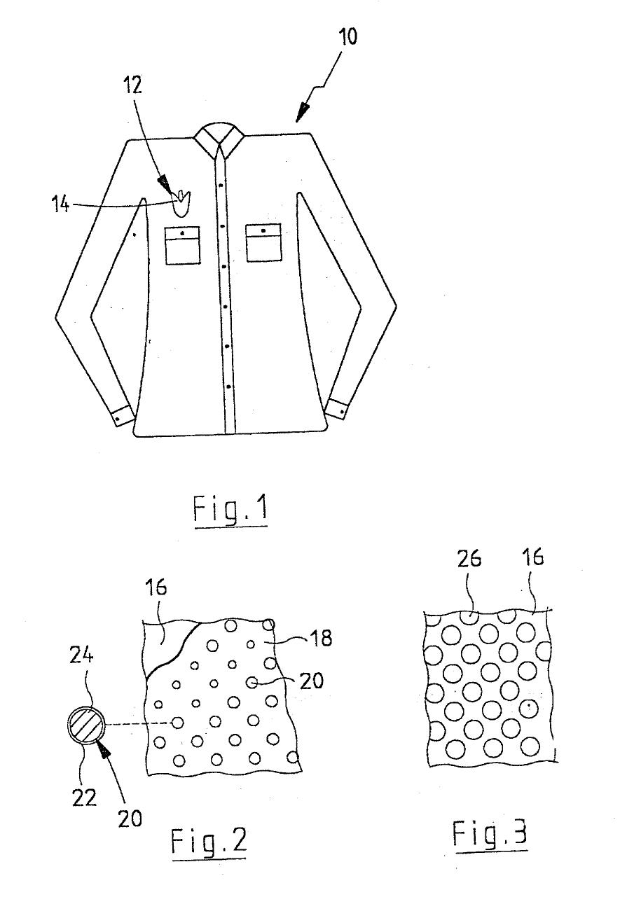

FIG. 2 shows an enlarged view of a section of an area of a garment including microparticles;

FIG. 3 shows a schematic view of the piece of textile shown in FIG. 2 after heat treatment by ironing;

FIG. 4 shows a similar view to FIG. 2, in which a section of a flexible hologram forming part of a hologram mark on a garment is reproduced, and

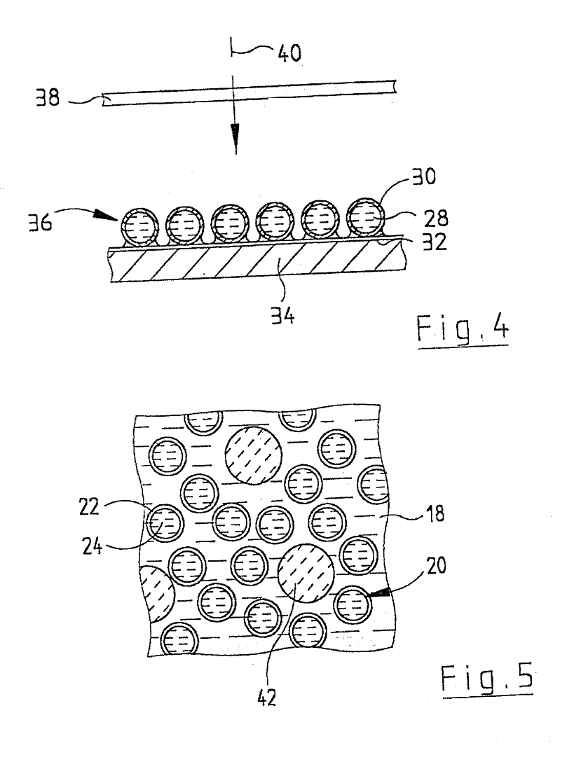

FIG. 5 shows a section of a printing ink containing microcapsules.

In FIG. 1 reference numeral 10 denotes a shirt. Said shirt is made of a textile material having an emblem 12 which is formed of microparticles 14. In this example the microparticles can be thermochromic ceramic microparticles which change color on contact with the warm body.

Thermochromic microparticles should also be understood to include microparticles in which their color saturation changes as a function of ambient temperature.

The microparticles 14 are preferably so selected that their color-change point is correlated to the standard body temperature of a garment worn by a user.

The correlation can be so arranged that the color of the microparticles is less intense and/or less conspicuous when the garment is worn by the user than when the garment is not worn. In that case the user is provided with an unambiguous indication of the genuineness of the garment which is especially clearly visible in the shop. This indication becomes less conspicuous and more discreet when the garment is worn.

Conversely, however, the thermochromic microparticles 14 can also be so selected that the marking formed by the demarcated area of microparticles becomes more clearly visible when the garment is worn.

Finally, the color-change temperature can also be set so that it is just reached or is not quite reached when the garment is worn. The thermochromic microparticles will then change their appearance depending on the ambient temperature, giving rise to interesting optical effects while wearing the garment.

Instead of thermochromic microparticles photochromic microparticles which change their color and/or their color saturation as a function of ambient light can also be used. Again, the photochromic microparticles can be so selected that the demarcated area of microparticles can be clearly seen under standard lighting conditions, or that the demarcated area of microparticles is clearly visible when standard lighting conditions are not present.

Alternatively, microparticles containing fluorescent or phosphorescent materials can be used. Such materials can be inorganic luminous substances or organic luminous substances.

The fluorescent or phosphorescent materials can be so selected that they are excited only by UV light, so that, firstly, it is possible to monitor genuineness by the demarcated area including microparticles but, secondly, the appearance of the garment is not conspicuous under normal conditions.

In the case of further modified microparticles the actual marking substances can be enclosed in the capsule wall of a microsphere. The use of microspheres also permits the use of optically marking substances which volatilize under the application of heat (sublimation) or deteriorate in their optical quality (especially through the influence of oxygen). Liquid color-active substances which would otherwise be eliminated can also be used when enclosed in microcapsules.

In all the above-mentioned cases the microparticles can be bonded to the textile material by using a binding agent. This allows greater freedom in the choice of microparticles, as they are not themselves responsible for the bonding to the textile material.

The use of a binding agent also provides a parameter by which the bonding of the microparticles to the textile material can be controlled. For example, a binding agent can be selected which is not water-resistant, or at least is not resistant to warm water containing a detergent. This enables the garment to be provided with a warranty mark which can be washed out by the user when it has performed its function.

Conversely, however, the binding agent can be so selected that, if desired by the user, the microparticles are permanently bonded to the textile material. Binding agents which harden under radiation, or binding agents containing thermoplastic components which can be permanently bonded to the textile base material by the application of heat (e.g. ironing) could be used for this purpose.

The demarcated areas containing microparticles can be produced using known printing processes, in particular screen printing. The demarcated area does not need to have a closed border. Patterns in the form of stripes are also possible. The demarcated area does not need to be visible on the garment under normal conditions. The demarcated areas taking over warranty functions can also be provided in areas of the garment which are not visible under normal wearing conditions, e.g. on the lower portion of a shirt.

The optically active microparticles preferably have a diameter in the range from approx. 0.5 to 500 μm. Such microparticles are well suited to screen printing and present virtually homogeneous surfaces on the textile material.

All microparticles which have different optical properties to the textile base material are optically active according to the present invention. In the simplest case they can simply be small particles of glass which produce an effect through their reflections. If such glass particles are embedded in a transparent matrix of binding agent, they have a muted effect through their dull sheen.

FIG. 2 shows a textile base material 16 which carries via a binding agent coating 18 microcapsules 20 the capsule walls 22 of which are destroyed under the application of heat (e.g. at the ironing temperature envisaged for the fabric concerned). In the embodiment considered here a sublimable dye 24 is enclosed inside the capsule wall 22.

If the user does not wish to have a quality seal on his garment, he can wash the garment and the microspheres 20 are washed out with the non-permanent binding agent coating 18. The garment then has a neutral appearance.

If the user wishes to retain an indication of origin on the garment, however, the user irons the emblem 12 before the first wash. The capsule walls 22 are thereby destroyed and the sublimable dye 24 contained inside the microcapsules 20 penetrates the binding agent coating 18 and from there penetrates the textile base material 16. Through thermosublimation images of the individual microspheres with enlarged diameter, denoted by 26 in FIG. 3, are thus obtained in the base material 16. After washing out the binding agent coating 18 a coloring of the garment present in the area of the emblem 12 is obtained.

A flexible hologram is an especially secure emblem 12. Such a hologram can be realized as shown in FIG. 4.

Microspheres 28 are produced from glass. They are surrounded by a light-sensitive layer 30 which can also perform the function of a binding agent coating. The glass spheres 28 coated in this way are applied while still in the glutinous state to a layer 32 of binding agent with which a textile base material 34 has been provided.

The light-sensitive layer 30 can contain, for example, compounds of silver in the usual manner. The base material of the layer 30 is so selected as to have good transparency. Similar base materials for light-sensitive layers are used for color reversal films.

As can be seen from FIG. 4, the glass spheres 28 carrying light-sensitive layers 30 form a substantially continuous layer of spheres 36 which can be exposed in a manner similar to a film coating. The sphere layer 36 is exposed using a holographic master 38 with the application of schematically represented monochromatic light 40.

After exposure the light-sensitive coatings 30 are developed and fixed, in the usual manner. Thereafter the sphere layer 36 forms a flexible hologram with the pattern resulting from the holographic master 38.

The light pattern arising on this hologram changes with the position of the hologram on the user. Interesting optical effects are thus produced by deformations of the garment of the kind which constantly occur while the garment is being worn.

Acrylates are particularly suitable as the wall material for microcapsules and as the binding agent, as they have good transparency, good binding agent properties and—if desired—good temperature resistance.

It is self-evident that in further modifications mixtures of microparticles and microspheres, as described above, can be used to achieve combinations of the above-described effects obtained therewith.

When printing microcapsules on a fabric using the rotary screen printing or the continuous screen printing process (and in the case of fragile microcapsules also when using the flat-bed screen printing process, if applicable) a printing ink as represented in FIG. 5 is preferably used: in addition to the microcapsules 20 spherical protective bodies 42 having a larger diameter than the microcapsules 20 are provided in the liquid medium 18. If the diameter of the microcapsules 20 is approx. 6 μm, the diameter of the protective bodies 42 can be approx. 10 μm. The protective bodies 42 absorb the load of the squeegee, thereby preventing the squeegee from crushing the microspheres under its pressure.

The protective bodies 42 are solid and are preferably produced from a transparent material such as glass or acrylic glass.

The concentration of the protective bodies is so selected that the stiff squeegee runs predominantly on protective bodies, in that it is always supported at a number of spaced points by protective bodies.

1. A textile material for a garment, characterized in that it has in a demarcated area microparticles bound by a binding agent and in that the microparticles impart a changed appearance to the material in the demarcated area.

2. A textile material according to claim 1, characterized in that the microparticles include ceramic material or glass.

3. A textile material according to claim 1, characterized in that the microparticles include a transparent plastics material.

4. A textile material according to claim 1, characterized in that the microparticles include microcapsules.

5. A textile material according to claim 1, characterized in that the microparticles contain a chemical compound which is selected from a fluorescent compound, a phosphorescent compound, a thermochromic compound, a photochromic compound and mixtures thereof.

6. A textile material according to claim 5, characterized in that the thermochromic compound changes its color at a temperature between 20° C. and 40° C.

7. A textile material according to claim 5, characterized in that the photochromic compound has a different color or a different color saturation in daylight and in artificial light.

8. A textile material according to claim 5, characterized in that the microparticles include ceramic material or glass and in that the chemical compound is an inorganic compound.

9. A textile material according to claim 5, characterized in that the microparticles include a transparent plastics material and in that the chemical compound is an organic compound.

10. A textile material according to claim 5, characterized in that the microparticles release the chemical compound then the textile material is ironed.

11. A textile material according to claim 1, characterized in that the microparticles are applied by screen printing.

12. A textile material according to claim 1, characterized in that the microparticles have a magnitude in the range from 0.5 to 500 μm.

13. A textile material according to claim 1, characterized in that the binding agent or the microparticles can be washed out.

14. A textile material according to claim 1, characterized in that the microparticles include thermoplastic material.

15. A textile material according to claim 1, characterized in that the microparticles include a metallic pigment.

16. A textile material according to claim 1, characterized in that the microparticles are at least partially covered by an exposed photographic coating.

17. A textile material according to claim 16, characterized in that the photographic coating has been exposed using a hologram.

18. A textile material according to claim 4, characterized in that the microcapsules (20) together with solid protective bodies (21) having a larger diameter than the microcapsules (42) are printed on using the screen printing process.

19. A textile material for a garment, characterized in that it has in a demarcated area microparticles bound by a binding agent, in that the microparticles impart a changed appearance to the material in the demarcated area and in that the microparticles include ceramic material, glass or a transparent plastics material.

20. A textile material according to claim 19, characterized in that the microparticles comprise microcapsules and in that the microparticles contain a chemical compound which is selected from a fluorescent compound, a phosphorescent compound, a thermochromic compound, a photochromic compound and mixtures thereof.

21. A textile material according to claim 20, characterized in that the photochromic compound has a different color or a different color saturation in daylight and in artificial light.

22. A textile material according to claim 20, characterized in that the microparticles are applied by screen printing.

23. A textile material according to claim 20, characterized in that that the microparticles are at least partially covered by an exposed photographic coating.

24. A textile material for a garment, characterized in that it has in a demarcated area microparticles bound by a binding agent, in that the microparticles impart a changed appearance to the material in the demarcated area, in that the microparticles comprise microcapsules and in that the microparticles contain a chemical compound which is selected from a fluorescent compound, a phosphorescent compound, a thermochromic compound, a photochromic compound and mixtures thereof.

25. A textile material according to claim 24, characterized in that the microparticles include ceramic material, glass or a transparent plastics material.

26. A textile material according to claim 24, characterized in that the photochromic compound has a different color or a different color saturation in daylight and in artificial light.

27. A textile material according to claim 24, characterized in that the microparticles are applied by screen printing.

28. A textile material according to claim 24, characterized in that that the microparticles are at least partially covered by an exposed photographic coating.

29. A textile material for a garment, characterized in that it has in a demarcated area microparticles bound by a binding agent, in that the microparticles impart a changed appearance to the material in the demarcated area, in that the microparticles include ceramic material, glass or a transparent plastics material and in that that the microparticles are at least partially covered by an exposed photographic coating.

30. A textile material according to claim 29, characterized in that the microparticles comprise microcapsules and in that the microparticles contain a chemical compound which is selected from a fluorescent compound, a phosphorescent compound, a thermochromic compound, a photochromic compound and mixtures thereof.

31. A textile material according to claim 29, characterized in that the photochromic compound has a different color or a different color saturation in daylight and in artificial light.

32. A textile material according to claim 29, characterized in that the microparticles are applied by screen printing.

33. A textile material according to claim 6, characterized in that that the thermochromic compound changes its color at a temperature between 25° C. and 30° C.

34. A textile material according to claim 5, characterized in that the photochromic compound has a different color or a different color saturation in daylight and in artificial light.
